(19) United States
(12) Patent Application Publication
(10) Pub. No.: US 2012/0273419 A1
(43) Pub. Date: Nov. 1, 2012

(54) Liquid torrefied biomass heat transfer medium removal

(76) Inventor: Herbert E. Fried, Owings Mills, MD (US)

(21) Appl. No.: 13/506,546

(22) Filed: Apr. 27, 2012

Related U.S. Application Data
(60) Provisional application No. 61/457,601, filed on Apr. 28, 2011.

(51) Int. Cl. B01D 11/00

(52) U.S. Cl. 210/639; 210/634

(57) ABSTRACT

A method for removal of a liquid heat transfer medium from pelletized biomass which has been torrefied by liquid torrefaction by immersing the torrefied biomass into a solvent bath which is miscible with the liquid heat transfer medium, then subjecting the torrefied biomass to the solvent for periodic sonification and/or agitation at a suitable temperature to substantially remove the liquid heat transfer medium from the biomass, separating the solvent from the torrefied biomass and filtering the solvent to remove liquid heat transfer medium residue.

### RELATED APPLICATIONS

This is a utility patent application claiming priority and the benefits of U.S. Provisional Patent Application No. 61/457,601, filed Apr. 28, 2011.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to a method for removing liquid from a biomass which has been torrefied by liquid torrefaction.

### BACKGROUND OF THE INVENTION

Wood chips, wood pellets, agro-pellets or peat can undergo the process of torrefaction to convert these materials into the respective torrefied matter, which becomes an advantageous feedstock for coal co-firing, gasification to produce liquid fuels and chemicals, thermal heating, etc. One type of torrefaction process utilizes a liquid heat transfer medium (LHTM) such as a vegetable oil to carry out the process. A potential drawback of such a process is that the liquid heat transfer medium, which can be highly expensive, is retained in the final torrefied product in amounts that can range from about 5% to greater than 50% by weight.

### SUMMARY OF THE INVENTION

The present invention is a method to remove and recycle the liquid heat transfer medium that is absorbed in and onto a torrefied biomass that is produced using a liquid heat transfer medium such as vegetable oil, peanut oil, olive oil or the like.

The removal of the liquid heat transfer medium (LHTM) from a biomass such as agro-pellets which have been torrefied by liquid torrefaction comprises the steps of immersing the torrefied biomass into a solvent bath which is miscible with the liquid heat transfer medium and subjecting the torrefied biomass and solvent to sonification and/or agitation for a predetermined period of time at a suitable temperature to remove the LHTM and separating the solvent from the torrefied biomass so that less than 1% of the solvent and LHTM remains in the biomass. The method additionally uses periodic sonication and/or agitation together with increased temperature or flow rate to accelerate removal of the LHTM from the torrefied biomass in a solvent.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a schematic depiction of the inventive process using a solvent extraction of the liquid heat transfer medium from the torrefied biomass; and

FIG. 2 is a schematic depiction of the inventive process using a sonic extraction of the liquid heat transfer medium from the torrefied biomass.

### DETAILED DESCRIPTION OF THE INVENTION

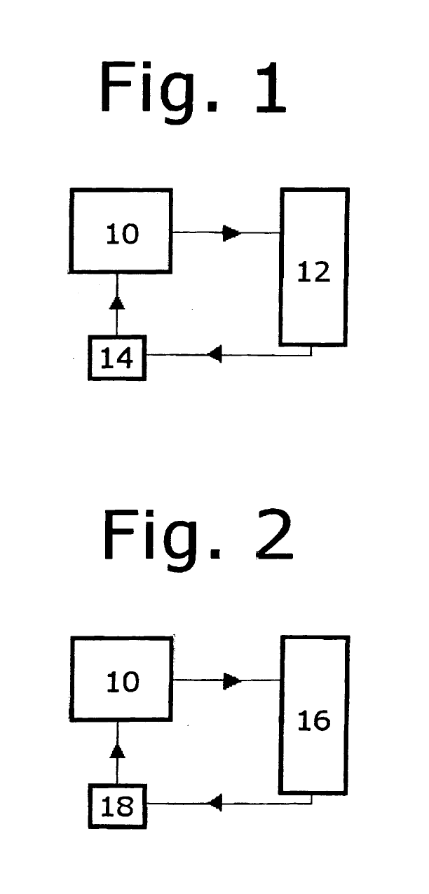

The preferred embodiments and best mode of the invention are shown in FIG. 1. In the process, a selected biomass is torrefied using a liquid heat transfer medium (LHTM) such a vegetable oil, peanut oil, olive oil or other high temperature non-polar oil as shown by numeral 10. The heat transfer medium is preferably a strong non-polar liquid compound. The liquid heat transfer medium is then separated from the torrefied biomass (chips, pellets, bricketts and the like which will be referred to in the following description as pellets,) by introducing the biomass pellets into a suitable solvent bath stage 12. This bath contains a non-polar solvent which is highly miscible with the liquid heat transfer medium. The polarity, dipole movement, polarizability and hydrogen bonding of a solvent determines what type of compounds it is able to dissolve and with what other liquid compounds it is miscible. The torrefied biomass is allowed to remain in contact with a non-polar solvent for a predetermined period of time, and at a specified temperature which allows efficient removal of over 90% of the LHTM, preferably ranging from 95% to 99.9% and most preferably from about 98% to about 99.9% of the LHTM from the torrefied biomass. The solvent bath can be agitated for a selected time at a temperature sufficient to increase the removal of the LHTM or preferably periodically sonicated for a selected period of time at a temperature, sufficiently to most efficiently increase the removal of the LHTM. The solvent used is a suitable liquid or gas which as a non-limiting example can be petroleum ether (Diethyl Ether), Hexane, Cyclohexane, Pentane, Cyclohexane, Benzene, Toulene, 1-4 Dioxane, Fluorocarbons, Carbon dioxide, Carbontetrachloride, Trichloroethylene, Flurohydrocarbon or a mixture of the solvents is then separated from the torrefied biomass such that the torrefied biomass becomes essentially solvent free, with removal of the solvent being accomplished by a distillation process stage 14 that permits both the recovery of the solvent and recovery of the liquid heat transfer medium that was previously bound to or residing in the torrefied biomass. The recovered liquid heat transfer medium is recycled back into the torrefaction stage 10. When a more volatile solvent is used, the solvent bath chamber can be pressurized. Accelerated rates of removal can be obtained with temperature increases and flow rate increases.

Alternately the torrefied pellets can be sonicated or agitated at a time and temperature sufficient to dislodge the LHTM from the pellets. The torrefied pellets can also be added to an immiscible liquid such as water and sonicated or agitated in a sonication or agitation stage 16 The LHTM is then separated at phase separation stage 18 or by extraction with a solvent to maximize interaction between the solvent and the captured liquid heat transfer medium. The LHTM having been recovered is recycled into the torrefaction stage 10.

If water is used, a surfactant is added to the sonication/agitation to remove the LHTM. It is noted that increasing the temperature of the bath and flow rate can speed up the process and increase the solvent miscibility with the LHTM which of course varies with the solvent composition. The sonication uses standard off the shelf equipment which is readily available and the agitation can be undertaken by moving screens.

### Example 1

Hexane extraction of torrefaction liquid from torrefied wood pellets previously torrefied in vegetable oil (Olive oil), 25.6 grams of torrefied pellets were mixed with 125 mL of Hexane in a 250 mL flask. The solution was allowed to stand for 10 minutes with periodic sonication at room temperature using a Branson Sonicator Model 5510. The solid pellets were filtered and rinsed with small portions of Hexane. The Hexane was evaporated resulting in an orange residue weighing 3.3 grams. The filtered pellets were added to another 250 mL flask containing 125 mL of Hexane and the resulting mixture was allowed to stand at room temperature with periodic sonication for approximately 15 minutes. Filtration of the resulting mixture and evaporation of the resulting filtrate afforded an additional 1.1 grams of orange residue. The above procedure was repeated with the filtered pellets at 50° C. without sonication for two additional cycles for 3 min each resulting in 0.6 g and 0.3 g by weight of residue being recovered for each cycle. Analysis of the dried pellets 2.8 g by weight using ACCS Method Aa4-38 revealed an oil residual content of only 0.4%; about 5.3 grams by weight of torrefaction medium residue were recovered for recycling.

The resulting oil-extracted pellets were allowed to stand in H₂0 for 11 months with no noticeable change in appearance. In contrast, the torrefied pellets that were not subjected to a solvent extraction procedure leached a slimy substance from the pellet into the aqueous phase.

### Example 2

Qualitative experiment on the effect of agitation or sonication on oil extraction from torrefied pellets.

Torrefied pellets from vegetable oil placed in a Hexane bath and then sonicated periodically at RT for 15 min resulted in a notably darker solution compared to a similar mixture that was periodically shaken over this period. This shows that agitation of the pellet/solvent mixture also enhances the extraction process but with less result than the sonication.

### CONCLUSION

It was unexpected that oil can be removed so effectively from the torrefied pellets without requiring the pellets to be previously crushed (commercially called oil expelling). Process efficiency is expected to be improved by employing commercial extraction technology. Utilization of multiple agro-pellet feeds, including biomass/coal mixtures and biomass/peat mixtures could also be utilized in the LHTM process.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A method for removal of a liquid heat transfer medium from a biomass which has been torrefied by the liquid heat transfer medium comprising the steps of:
a. immersing the torrefied biomass into a solvent bath which is miscible with the liquid heat transfer medium;
b. subjecting the torrefied biomass to the solvent for a predetermined period of time at a suitable temperature to substantially remove the liquid heat transfer medium from the torrefied biomass;
c. separating the liquid heat transfer medium from the solvent; and
d. recycling the separated liquid heat transfer medium back into the torrefaction liquid.

2. A method for removal of a liquid heat transfer medium from a biomass as claimed in claim 1 wherein said solvent bath is sonicated.

3. A method for removal of a liquid heat transfer medium from a biomass as claimed in claim 1 wherein said solvent bath is agitated.

4. A method for removal of a liquid heat transfer medium from a biomass as claimed in claim 1 including the step of removing said solvent from said torrefied biomass by a distillation process to create a heat transfer medium residue which is recycled back into the torrefaction liquid.

5. A method for removal of a liquid heat transfer medium from a biomass as claimed in claim 1 wherein said torrefaction liquid is non-polar.

6. A method for removal of a liquid heat transfer medium from a biomass as claimed in claim 1 wherein said biomass is in pellet form.

7. A method for removal of a liquid heat transfer medium from a biomass as claimed in claim 1 wherein said liquid heat transfer medium is an oil.

8. A method for removal of a liquid heat transfer medium from a biomass as claimed in claim 1 wherein said solvent is taken from one of a group of non-polar solvents consisting of Pentane, Cyclopentane, Hexane, Hexane Cyclohexane, Benzene Toluene, 1,4-Dioxane, Diethyl Ether, Fluorocarbons, Carbon dioxide, Carbontetrachloride, Trichloroethylene and a mixture of the listed solvents.

9. A method for removal of a liquid heat transfer medium as claimed in claim 1 wherein about 95% to about 99.9% of said liquid heat transfer medium is removed from said torrefied biomass.

10. A method for removal of a liquid heat transfer medium as claimed in claim 1 wherein about 98% to about 99.9% of said liquid heat transfer medium is removed from said torrefied biomass.

11. A method for removal of a liquid heat transfer medium from a torrefied biomass as claimed in claim 1 wherein said biomass is a solid non-granular structure.

12. A method for removal of a liquid heat transfer medium from a biomass as claimed in claim 1 wherein said torrefied biomass is initially placed in a liquid bath including a surfactant.

13. A method for removal of a non-polar liquid heat transfer medium from a biomass having a size greater than granular which has been torrefied by liquid torrefaction comprising the steps of:
a. immersing the torrefied biomass into a non-polar solvent bath;
b. subjecting the torrefied biomass to sonication for a predetermined period of time at a suitable temperature to substantially remove at least about 95% of the non-polar liquid heat transfer medium from the torrefied biomass;
c. separating the torrefied biomass from the solvent bath; and
d. removing the solvent from the torrefied biomass.

14. A method for removal of a liquid heat transfer medium from a biomass as claimed in claim 13 wherein said liquid heat transfer medium is an oil.

15. A method for removal of a liquid heat transfer medium from a biomass as claimed in claim 13 wherein said removed liquid heat transfer medium is recovered from said liquid bath and reused for the liquid torrefaction of a biomass.

16. A method for removal of a liquid heat transfer medium from a biomass as claimed in claim 13 wherein said biomass is in pellet form.

17. A method for removal of a liquid heat transfer medium from a biomass as claimed in claim 13 wherein said solvent is taken from one of a group of non-polar solvents consisting of Pentane, Cyclopentane, Hexane, Cyclohexane, Benzene, Toluene, 1,4-Dioxane, Diethyl Ether, Fluorocarbons, Carbon dioxide, Carbontetrachloride, Trichloroethylene and a mixture of said solvents.

18. A method for removal of a non-polar liquid heat transfer medium from a biomass having a size greater than granular which has been torrefied by liquid torrefaction comprising the steps of:
a. immersing the torrefied biomass into a non-polar solvent bath;
b. subjecting the torrefied biomass to agitation for a predetermined period of time at a suitable temperature to substantially remove at least about 95% of the liquid heat transfer medium from the torrefied biomass;
c. separating the torrefied biomass from the solvent bath; and
d. removing the solvent from the torrefied biomass.

19. A method for removal of a liquid heat transfer medium from a biomass as claimed in claim 18 wherein said liquid heat transfer medium is an oil.

20. A method for removal of a liquid heat transfer medium from a biomass as claimed in claim 19 wherein said torrefied biomass is initially placed in a solvent bath heated above ambient temperature.

21. A method for removal of a liquid heat transfer medium from a biomass as claimed in claim 18 wherein said removed liquid heat transfer medium is recovered from said liquid bath and reused for the liquid torrefaction of a biomass.

22. A method for removal of a liquid heat transfer medium from a biomass as claimed in claim 18 wherein said biomass is in pellet form.

23. A method for removal of a liquid heat transfer medium from a biomass as claimed in claim 19 wherein said solvent is taken from one of a group of non-polar solvents consisting of Pentane, Cyclopentane, Hexane, Cyclohexane, Benzene, Toluene, 1,4-Dioxane, Diethyl Ether, Fluorocarbons, Carbon dioxide, Carbontetrachloride, Trichloroethylene and a mixture of said solvents.

24. A method for removal of a non-polar liquid heat transfer medium from biomass pellets which have been torrefied by liquid torrefaction comprising the steps of:
a. immersing the torrefied biomass into a non-polar solvent liquid bath;
b. subjecting the torrefied biomass to sonication for a predetermined period of time at a suitable temperature to substantially remove non-polar liquid heat transfer medium from the torrefied biomass;
c. separating the torrefied biomass from the solvent liquid bath;
d. repeating steps a.-c. a plurality of times until at least about 98% of the non-polar liquid heat transfer medium is removed from the torrefied biomass; and
e. removing the solvent from the torrefied biomass.

25. A method for removal of a non-polar liquid heat transfer medium from biomass pellets as claimed in claim 24 wherein said removed liquid heat transfer medium is in the form of residue.
